(19) United States
(12) Patent Application Publication
(10) Pub. No.: US 2010/0027075 A1
(43) Pub. Date: Feb. 4, 2010

(54) IMAGE FORMING APPARATUS AND PRINTING METHOD THEREOF

(75) Inventor: Ho-keun LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/410,757

(22) Filed: Mar. 25, 2009

(30) Foreign Application Priority Data
Aug. 1, 2008 (KR) 2008-75752

(51) Int. Cl. H04N 1/40

(52) U.S. Cl. 358/3.06

(57) ABSTRACT

An image forming apparatus and a printing method thereof, the printing method including: generating continuous tone data corresponding to an image area of print data and binary data corresponding to a text area of the print data; generating merged data based on the continuous tone data and the binary data; and performing a half-toning of the merged data to generate final data to be printed on a print medium.

### CROSS-REFERENCE TO RELATED APPLICATION

This application claims the benefit of Korean Application No. 2008-75752, filed Aug. 1, 2008 in the Korean Intellectual Property Office, the disclosure of which is incorporated herein by reference.

### BACKGROUND OF THE INVENTION

1. Field of the Invention

Aspects of the present invention relate to an image forming apparatus and a printing method thereof, and more particularly, to an image forming apparatus and a printing method thereof adjusting a density of a final image formed on a print medium.

2. Description of the Related Art

An image forming apparatus (such as a printer, a multi-function peripheral, a facsimile, etc.) receives print data from a host apparatus (such as a computer, a personal digital assistant (PDA), etc.), and prints the received print data on a print medium (such as paper, a transparency, etc.). However, to reduce a transmitted data amount of the print data, a mixed raster content (MRC) method that is described in ITU-T.44 has been widely used as a data compressing transmitting method for a mixed document in which an image and text are combined.

According to the MRC method, the print data is divided into binary data of a text area, and continuous tone data of an image area, and the divided data are respectively compressed by different compression methods. That is, the binary data of the text area is compressed using a non loss compression method (such as a modified modified read (MMR) or a joint bi-level image experts group (JBIG)), and the continuous tone data of the image area is compressed by a loss compression method (such as a joint photographic experts group (JPEG)). The compressed data is then transmitted to the image forming apparatus.

The image forming apparatus receives the compressed data, and decodes the compressed data into continuous tone data and binary data. If the decoded continuous tone data is color data (such as RGB or YCbCr data), the decoded continuous tone data is converted into print color data (such as CMYK) by a color conversion, and a half-toning is applied to the color-converted continuous tone data. Accordingly, the continuous tone data of 8 bit is converted to 1 bit. The decoded binary data is merged with the half-toned continuous tone data to be transmitted to a printing engine in the image forming apparatus. Accordingly, the mixed document combining the image area and the text area is outputted.

However, the binary data is directly supplied to the printing engine, and is displayed as a single ink dot or toner dot on a print medium without condition. Accordingly, a density adjustment of the text area is impossible. Specifically, if an ink dot is directly printed on a print medium according to the binary data, ink may be excessively spread on the print medium, and the print medium may become wet and torn in a severe case.

Also, in case of the text area, ink of a displayed text may spread to deteriorate an image quality. In a case of an image forming apparatus using a toner as a developer, since much toner is transferred to a print medium, it is difficult to fuse the toner on the print medium and a text image may be printed excessively dense in an output.

### SUMMARY OF THE INVENTION

Aspects of the present invention provide an image forming apparatus and a printing method thereof to adjust a density of a final image formed on a print medium by merging print data divided into a text area and an image area. Aspects of the present invention also provide an image forming apparatus and a printing method thereof to reduce a spreading of a developer on a print medium, and to save a developer. Aspects of the present invention also provide an image forming apparatus and a printing method thereof emphasizing a boundary of a final image to be formed on a print medium and, concurrently, reducing an unnecessary waste of developer.

According to an aspect of the present invention, there is provided a printing method of an image forming apparatus, the printing method including: generating, from print data, continuous tone data corresponding to an image area of the print data and binary data corresponding to a text area of the print data; generating merged data based on the continuous tone data and the binary data; and performing a half-toning of the merged data to generate final data to be printed on a print medium.

The generating of the merged data may include generating the merged data to reduce a density of a final image corresponding to the final data as compared to a density of an original image corresponding to the print data.

The generating of the merged data may include selecting, as the merged data, first tone data that has a lower density than the binary data or the continuous tone data depending on the binary data.

The first tone data may be variably set.

The generating of the merged data may include generating the merged data so that a density decrease degree of the final image is adjusted according to a property of the print data.

The property of the print data may be based on a boundary of the text area.

A density of the boundary of the text area in the final image may be greater than a density of a non boundary of the text area in the final image.

The generating of the merged data may include: determining whether the binary data corresponds to the boundary of the text area; and selecting second tone data that has a lower density than the binary data, third tone data that has a higher density than the second tone data, or the continuous tone data as the merged data depending on the binary data and a boundary detecting result.

According to another aspect of the present invention, there is provided an image forming apparatus, including: an interface unit to receive print data; and an image processing unit to generate, from the print data, continuous tone data corresponding to an image area of the print data and binary data corresponding to a text area of the print data, to generate merged data based on the continuous tone data and the binary data, and to perform a half-toning of the merged data to generate final data to be printed on a print medium.

The image processing unit may generate the merged data to reduce a density of a final image corresponding to the final data as compared to a density of an original image corresponding to the print data.

The image processing unit may include a multiplexer to select, as the merged data, first tone data that has a lower density than the binary data or the continuous tone data depending on the binary data.

The first tone data may be variably set.

The image processing unit may generate the merged data so that a density decrease degree of the final image is adjusted according to a property of the print data.

The property of the print data may be based on a boundary of the text area.

The density of the boundary of the text area in the final image may be greater than a density of a non-boundary of the text area in the final image.

The image processing unit may include: a boundary detecting unit to determine whether the binary data corresponds to a boundary of the text area; and a multiplexer to select, as the merged data, second tone data that has a lower density than the binary data, third tone data that has a higher density than the second tone data, or the continuous tone data depending on the binary data and a boundary detecting result.

According to yet another aspect of the present invention, there is provided an image processing method to process print data, the method including: generating merged data based on continuous tone data corresponding to an image area of the print data and binary data corresponding to a text area of the print data; and performing a half-toning of the merged data to generate final data to be printed on a print medium, wherein the generating of the merged data includes generating the merged data to reduce a density of a final image corresponding to the final data as compared to a density of an original image corresponding to the print data.

According to still another aspect of the present invention, there is provided an image processing method to process print data, the method including: generating merged data based on continuous tone data corresponding to an image area of the print data and binary data corresponding to a text area of the print data; and performing a half-toning of the merged data to generate final data to be printed on a print medium, wherein the generating of the merged data includes generating the merged data so that a density of a boundary of the text area in a final image corresponding to the final is greater than a density of a non-boundary of the text area in the final image, and a density of the text area in the final image is less than a density of the text area in an original image corresponding to the print data.

According to another aspect of the present invention, there is provided an image processing unit to process print data, the image processing unit including: a decoding unit to generate, from the print data, continuous tone data corresponding to an image area of the print data and binary data corresponding to a text area of the print data; a merged data generating unit to generate merged data based on the continuous tone data and the binary data; and a half toning unit to perform a half-toning of the merged data to generate final data to be printed on a print medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image forming apparatus according to an embodiment of the present invention;

FIG. 2 is a block diagram of an image processing unit of the image forming apparatus in FIG. 1;

FIG. 3 is a schematic view of a merged data generating unit of the image processing unit in FIG. 2;

FIGS. 4 and 5 are enlarged views of a final image by a conventional image forming apparatus and a final image by the image forming apparatus according to an embodiment of the present invention;

FIG. 6 is a block diagram of an image processing unit of an image forming apparatus according to another embodiment of the present invention;

FIG. 7 is a schematic view of a merged data generating unit of the image processing unit in FIG. 6;

FIG. 8 is a block diagram of an image processing unit of an image forming apparatus according to another embodiment of the present invention;

FIG. 9 is a schematic view of a merged data generating unit of the image processing unit in FIG. 8;

FIGS. 10 and 11 are enlarged views of a final image by the image forming apparatus in FIG. 1 and a final image by the image forming apparatus according to another embodiment of the present invention;

FIG. 12 is a flowchart of a printing method of an image forming apparatus according to an embodiment of the present invention;

FIG. 13 is a flowchart of a printing method of an image forming apparatus according to another embodiment of the present invention;

FIG. 14 is a flowchart of a printing method of an image forming apparatus according to another embodiment of the present invention; and

FIGS. 15A and 15B are flowcharts of a printing method of an image forming apparatus according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

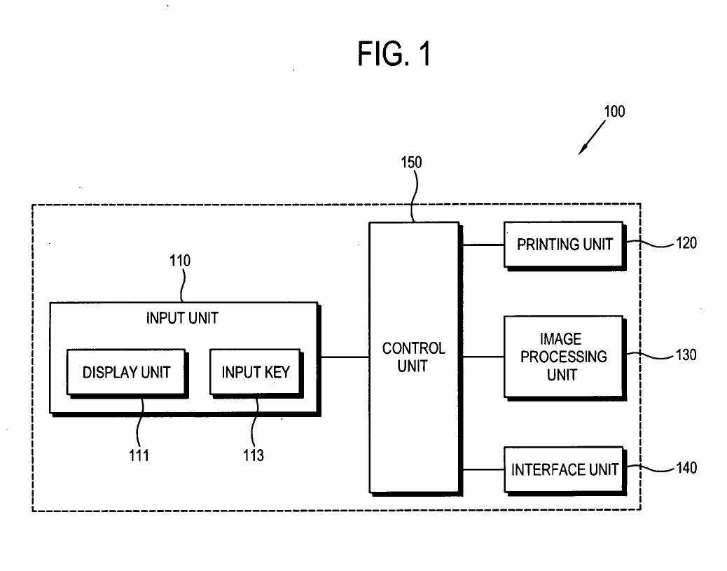

FIG. 1 is a block diagram of an image forming apparatus 100 according to an embodiment of the present invention. Referring to FIG. 1, the image forming apparatus 100 includes an interface unit 140 to receive print data, and an image processing unit 130 to process the print data received through the interface unit 140 to generate final data.

Specifically, the image processing unit 130 generates, from the received print data, continuous tone data corresponding to an image area and binary data corresponding to a text area. Here, the print data may be data divided according to an image area and a text area and compressed by a mixed raster content (MRC) method, as described above. However, it is understood that aspects of the present invention are not limited thereto, and the compressed data may not be compressed by the MRC method. For example, the print data may be compressed by a method that divides into an area (hereinafter, referred to as “text area”) having a high saturation such as a text or a graphic (table, line, diagram, etc.), and an image area, and compresses the divided data. Also, it is understood that, according to other aspects, the compressed data may not be received from an external host apparatus. For example, the image forming apparatus 100 may include a scanning unit to scan a document so that the compressed data is generated by the scanning unit.

In this case, the image processing unit 130 decodes the compressed print data and divides the print data into continuous tone data of the image area and binary data of the text area, thereby generating the continuous tone data and the binary data. Here, as described above, the text area may include a graphic area having a high saturation as well as a text itself.

It is understood that, according to other aspects, the print data may be data divided according to the image area and the text area, only one area of which is compressed. Alternatively, the print data may be data just divided into the image data and the text data, and not compressed at all. In this case, the image processing unit 130 may generate the continuous tone data and the binary data by dividing the print data into the continuous tone data of the image area and the binary data of the text area without a separate decompression.

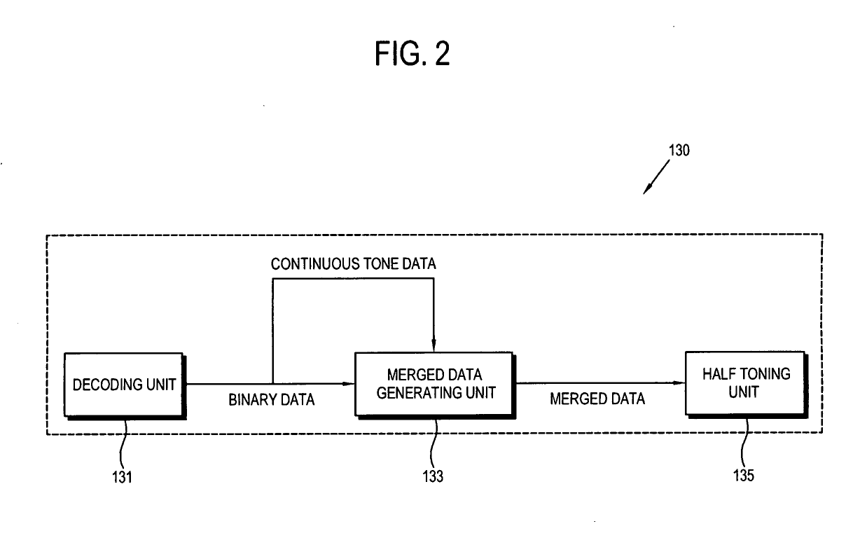

As described above, the image processing unit 130 generates merged data based on the generated continuous tone data and binary data, and performs a half-toning for the merged data to generate final data. In more detail, as shown in FIG. 2, the image processing unit 130 includes a decoding unit 131 to decode the print data received from the interface unit 140 into binary data and continuous tone data, a merged data generating unit 133 to generate merged data based on the decoded continuous tone data and binary data, and a half-toning unit 135 to perform a half-toning of the merged data to generate final data.

Here, the image processing unit 130 generates the merged data so that a density of a final image corresponding to the final data can be less than a density of an original image corresponding to the print data.

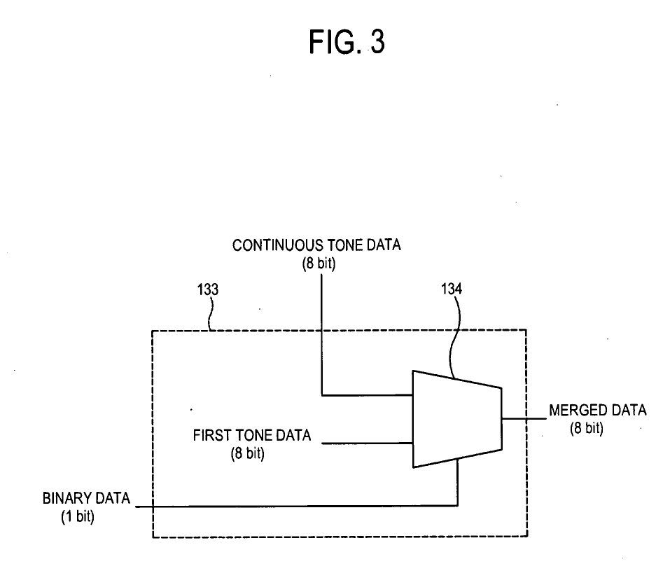

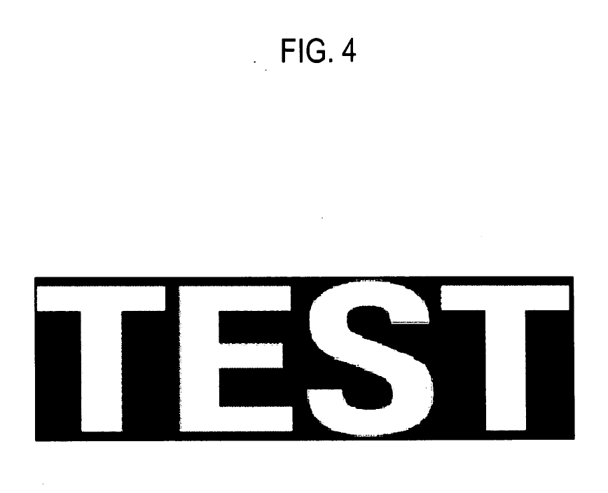

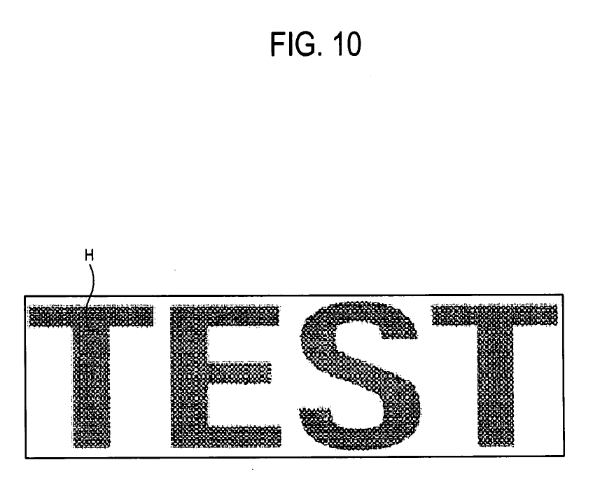

FIG. 3 is a schematic view of a merged data generating unit of the image processing unit in FIG. 2. Referring to FIG. 3, the merged data generating unit 133 includes a multiplexer 134. The multiplexer 134 selects one of continuous tone data corresponding to the image area divided by the decoding unit 131 depending on the binary data corresponding to the text area, and first tone data as the merged data. The text area is an area in which ink or a developer (such as a toner) is applied so that text can be displayed, and includes a background area of the text as well as the text itself. For example, as shown in FIG. 4, the developer can be applied to a background area so that a text area in which letters “TEST” of white (blank) is expressed. Also, as shown in FIG. 10, the developer can be applied to the letters “TEST” itself so that a text area having the text is expressed. Also, the text area may be an area of data that is capable of being expressed with two levels except the continuous tone data. Furthermore, the text area may include a table or the like based on a line as well as a text.

The first tone data has a lower density than the binary data. That is, the density of an image corresponding to the first tone data is lower than the density of an image corresponding to the binary data. In more detail, the density of the text area of the final image corresponding to the first tone data is lower than the density of the text area of the original image corresponding to the binary data. The first tone data is a value stored in a memory (not shown), and may be a fixed value or variable value. That is, the first tone data may be a fixed value pre-stored in a memory (such as a read only memory (ROM)) in a product release, or may be a value supplied from a host apparatus according to an image adjustment. However, it is understood that aspects of the present invention are not limited thereto. For example, the first tone data may be a value inputted by a user though an input unit 110 (illustrated in FIG. 1). That is, if the user inputs a desired density, the first tone data may vary according thereto. For example, if the user wants the density of the final image to be approximately 80% and inputs this percentage to the input unit 110, the first tone data may be changed to a value corresponding thereto (for example, to 200).

The selecting process of the merged data will now be described in more detail. If the binary data is 1 (i.e., a printing dot is to be formed in the text area corresponding to the binary data), first tone data having a lower density than the binary data is outputted as the merged data. For example, if 255 is regarded as 100% density and 0 is regarded as 0% density (i.e., blank) in a plurality of tones of 256 increments of 0-255, the first tone data may be a value less than 255, which is a lower density than the 100% density. That is, the first tone data may be a value greater than 0 and less than 255. Here, as the value of the first tone data approaches 255, the density of the text area of the final image increases. Conversely, as the value of the first tone data approaches 0, the density of the text area of the final image decreases. Here, the first tone data may be a value corresponding to the density of approximately 70-90%.

On the other hand, if 255 is regarded as 0% density (blank) and 0 is regarded as 100% density in a plurality of tones of 0-255, the first tone data may be a value exceeding 0, which is a lower density than the 100% density. That is, the first tone data may be a value greater than 0 and less than 255. Here, as the value of the first tone data approaches 0, the density of the text area of the final image increases. Conversely, as the value of the first tone data approaches 255, the density of the text area of the final image decreases. Here, the first tone data may be a value corresponding to the density of approximately 70-90%.

Referring back to FIG. 2, the half-toning unit 135 performs a half-toning of the merged data outputted by the multiplexer 134 to generate final data. Specifically, since the merged data outputted from the multiplexer 134 is a kind of continuous tone data having a plurality of level values (8 bit) of 0-255, the half-toning unit 135 performs the half-toning for the merged data to generate an image data of 1 bit (0 or 1) as the final data. The half-toning method may be performed according to a screen method, an error diffusion method, etc. Alternatively, other known methods may be applied thereto.

Accordingly, the density of the final image corresponding to the final data and the density of the original image corresponding to the printing data can differ. That is, the density of the final image may be adjusted to be different from the density of the original image. Also, the density of the text area of the final image may be adjusted to be lower than the density of the text area of the original image. Accordingly, if the text area of the final image is developed by ink as a developer, spreading of the ink may be reduced. In particular, if the text area is large, a print medium may be prevented from getting excessively wet, and an ink drying speed may be improved. Also, since the density of a developer may be reduced in printing with the developer (such as ink or a toner), the developer may be saved.

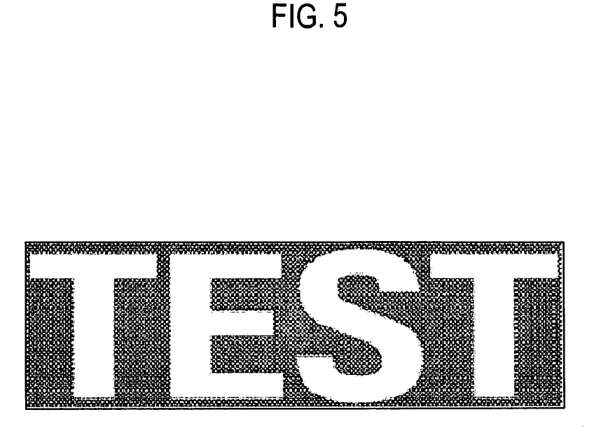

FIGS. 4 and 5 are enlarged views of a final image by a conventional image forming apparatus (FIG. 4) and a final image by the image forming apparatus 100 according to an embodiment of the present invention (FIG. 5). If “TEST” in a black background is to be printed, in the conventional final image as shown in FIG. 4, since the density of the black background is 100%, the developer may be spread into the white ‘TEST’ letters. That is, the possibility of a spreading of the developer is significantly high. In particular, if the developer is ink, it is significantly possible that the ink spreads into the letters “TEST”, and an ink dot is excessively formed in the black background so that a print medium can get wet and an ink drying time can increase.

On the other hand, in case of the image forming apparatus 100 according to an embodiment of the present invention, as shown in FIG. 5, the density of the black background is shown to significantly decrease in comparison with FIG. 4. Accordingly, the possibility of spreading of the ink into the letters “TEST” is reduced, and the density of the ink dot (ratio of dots to which a real ink is jetted to a total number of expressible dots) decreases, thereby reducing the ink drying time. Also, the developer may be saved.

A resolution changing unit (not shown) may be interposed between the merged data generating unit 133 and the half-toning 135 to change a resolution of the merged data. For example, if the resolution of a printing data is determined as 600 dpi, the resolution changing unit may change the resolution of the merged data from 600 dots per inch (dpi) to another resolution (for example, 1200 dpi).

As shown in FIG. 1, the image forming apparatus 100 further includes a printing unit 120 to print the final data, and a control unit 150 to control total processes from receiving the print data to outputting the print data. Specifically, if print data is received from the interface unit 140, the control unit 150 controls the image processing unit 130 to generate the final data from the print data. Also, the control unit 150 controls the printing unit 120 to print the generated final data on a print medium.

The image forming apparatus 100 also includes the input unit 110 to receive a density from a user to adjust the density of the final image. The input unit 110 includes a display unit 111 to display a density determining user interface (UI), and an input key 113 to input the density.

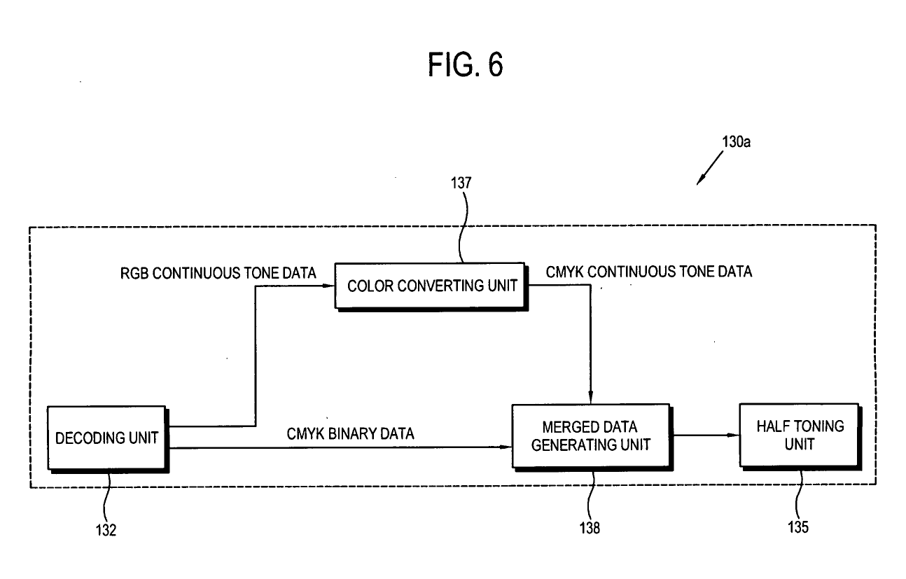

FIG. 6 is a block diagram of an image processing unit 130a of an image forming apparatus according to another embodiment of the present invention. The image forming apparatus 100 illustrated in FIG. 1 is a black and white image forming apparatus receiving black and white print data and printing with a single color developer. However, the image forming apparatus including the image processing unit 130 illustrated in FIG. 6 is capable of color printing with a plurality of colors. Other components of the image forming apparatus including the image processing unit 130 illustrated in FIG. 6 may be the same as those illustrated in FIG. 1, and the description thereof will be omitted.

Referring to FIG. 6, the image processing unit 130a includes a decoding unit 132 to decode the print data into RGB continuous tone data and CMYK binary data, a color converting unit 137 to convert the decoded RGB data into CMYK data, a merged data generating unit 138 to generate merged data based on the CMYK binary data and CMYK continuous tone data, and a half-toning unit 135 to perform a half-toning of the merged data.

When decoding the print data, the decoding unit 132 may convert RGB binary data corresponding to the text area into CMYK binary data. Specifically, the CMYK binary data is generated from the RGB binary data, such that if a text is yellow text having a red (R) value that is 255 (i.e., 100%) and a green (G) value that is 255 (i.e., 100%), a Y value is supplied with a binary data of 1 so that only a yellow developer be used. On the other hand, if a text is red text having only an R value that is 255 (i.e., 100%), binary data of 1′ is allocated to a magenta (M) value, and binary data of 1 is allocated to a Y value, thereby converting the RGB data into the CMYK data.

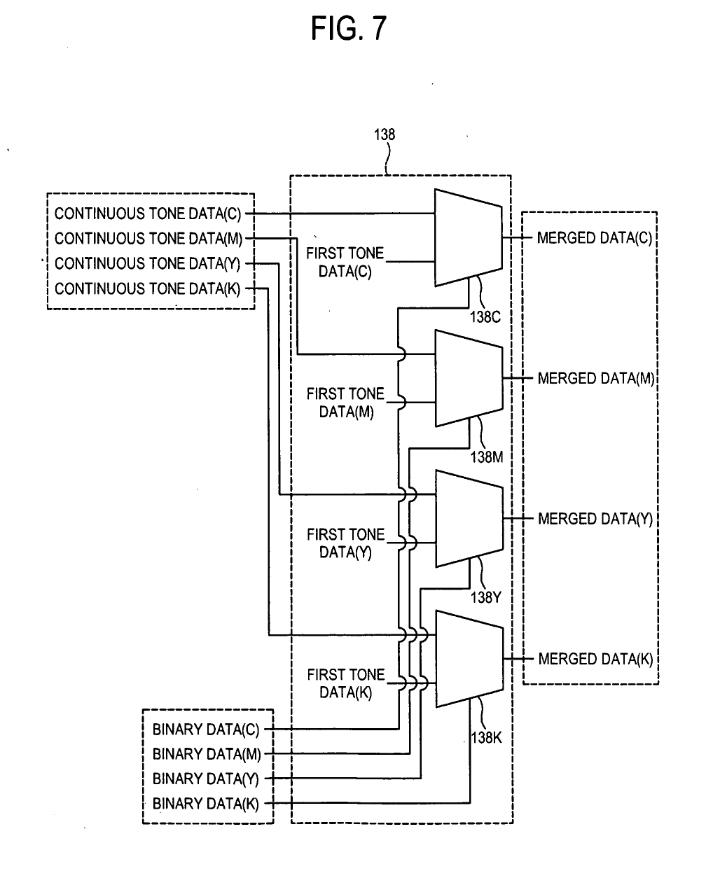

The merged data generating unit 138 generates the merged data by merging the CMYK continuous tone data and the CMYK binary data outputted from the color converting unit 137. FIG. 7 is a schematic view of a merged data generating unit 138 of the image processing unit 130a in FIG. 6. Referring to FIG. 7, the merged data generating unit 138 includes four multiplexers 138C, 138M, 138Y and 138K to generate the merged data by each color CMYK.

A process of generating merged data C of the color cyan (C) will now be described. The multiplexer 138C selects binary data of the color C in CMYK binary data. That is, first tone data C or continuous tone data C that is continuous tone data of the color C is selected as merged data according to binary data C. Specifically, if the binary data C is 1, the first tone data C is selected as the merged data C. Conversely, if the binary data C is 0, the continuous tone data C is selected as the merged data C. Accordingly, an image area and a text area are merged to generate the merged data corresponding to a page in a color C channel. Here, the first tone data C is determined to have a lower density than the binary data of the color C. That is, the first tone data C is determined so that the density of an image corresponding to the first tone data C is lower than the density of an original image corresponding to the binary data C.

For example, it is assumed that continuous tone data C of the color C has tones of 256 increments of 0-255, 255 is regarded as 100% density, and 0 is regarded as 0% density (i.e., blank). In this case, the first tone data C may be a value less than 255, which is a lower density than the 100% density. That is, the first tone data C may be a value greater than 0 and less than 255. Here, as the value of the first tone data C approaches 255, the density of the text area of the final image increases. In contrast, as the value of the first tone data C approaches 0, the density of the text area of the final image decreases. Here, the first tone data C may be a value corresponding to a density of approximately 70-90%.

Processes of generating merged data M, Y and K based on continuous tone data M, Y and K of the colors M, Y and K, and binary data M, Y and K of colors corresponding thereto may be the same as the merging process of the color C described above. Accordingly, a detailed description thereof will be omitted herein.

The generated merged data C, M, Y and K are respectively transmitted to a printing unit 120 so that a color image of CMYK can be formed on a print medium. Here, the printing unit 120 may include at least one of a plurality of ink cartridges storing inks of CMYK and a plurality of developing cartridges storing toners of CMYK.

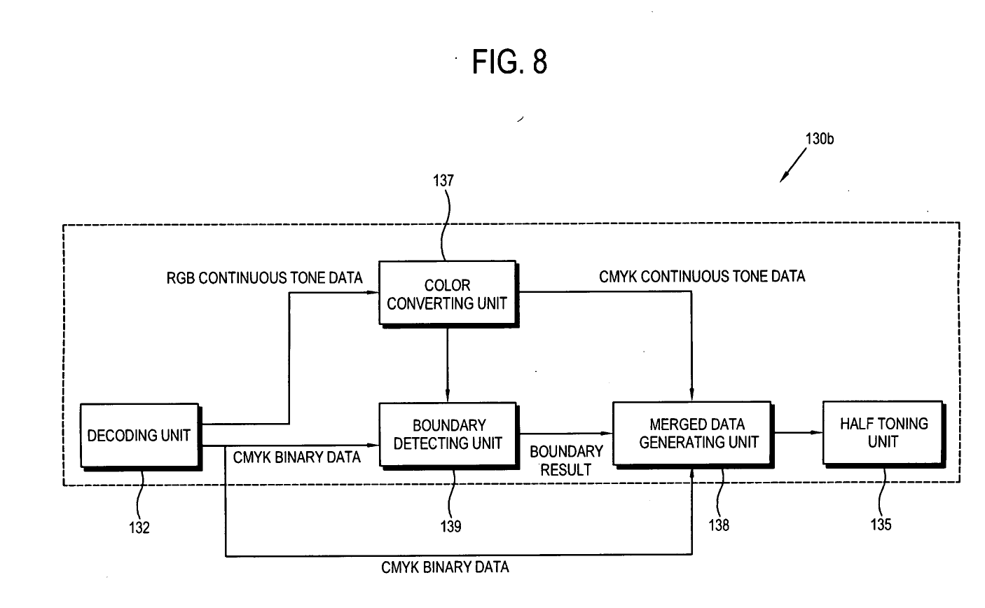

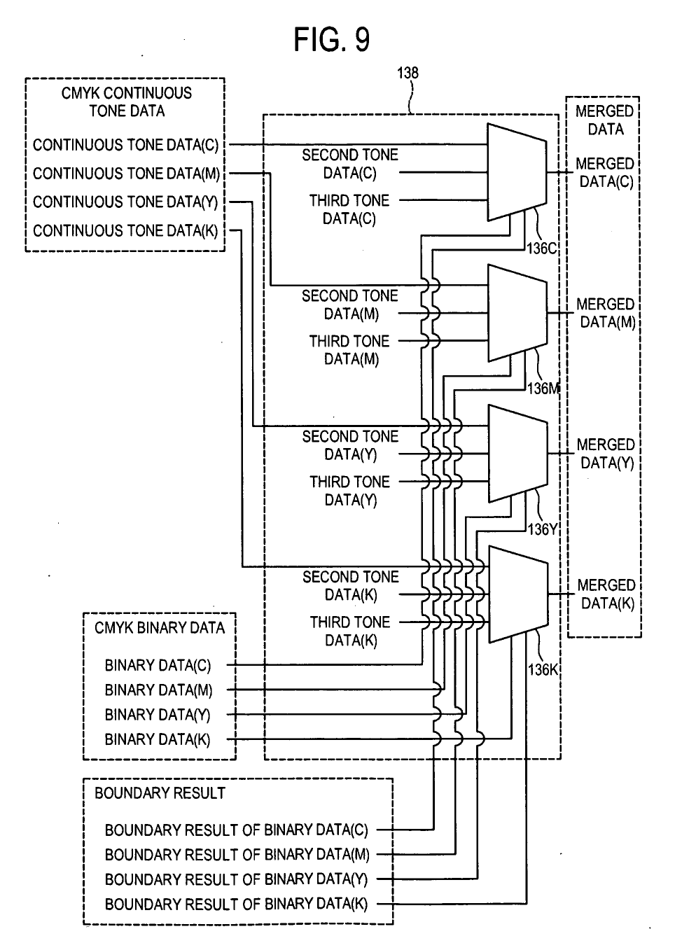

Hereinafter, an image forming apparatus according to another embodiment of the present invention will be described with reference to FIGS. 8 and 9. The image forming apparatus according to the third exemplary embodiment of the present invention includes an image processing unit 130b.

FIG. 8 is a block diagram of the image processing unit 130b. Referring to FIG. 8, the image processing unit 130b includes a decoding unit 132, a color converting unit 137, a boundary detecting unit 139, a merged data generating unit 138, and a half-toning unit 135. Here, the decoding unit 132 and the color converting unit 137 may correspond to those described above with reference to FIG. 6.

The boundary detecting unit 139 detects a boundary of a text area from CMYK binary data. Specifically, the boundary may be detected by using an outline detecting algorithm. The outline detecting is accomplished by using a variation of a brightness value by a differential operator. However, it is understood that aspects of the present invention are not limited thereto.

The merged data generating unit 138 generates the merged data based on the binary data, the boundary detecting result, and the continuous tone data so that a boundary portion and a non boundary portion can be divided in the text area, and the boundary portion can have a relatively higher density than the non boundary portion. In more detail, the merged data generating unit 138 selects second tone data, third tone data, or continuous tone data corresponding to the image area as the merged data according to the binary data and the boundary result detected by the boundary detecting unit 139.

Here, the second tone data is determined to have a lower density than the binary data, and the third tone data is determined to have a higher density than the second tone data. That is, the second tone data is determined so that the density of an image corresponding to the second tone data can be lower than the density of an image corresponding to the binary data. Furthermore, the third tone data is determined so that the density of an image corresponding to the third tone data can be higher than the density of an image corresponding to the second tone data.

Specifically, for an area corresponding to the non boundary portion of the text area, the second tone data is outputted as the merged data. For an area corresponding to the boundary portion of the text area, the third tone data is outputted as the merged data. Accordingly, for the text area of the print data, the density of the final image totally decreases in comparison with the original image, but the density of the boundary portion therein increases in comparison with the non boundary portion. Accordingly, the boundary portion in the text area appears relatively deep in comparison with the non boundary portion, thereby supplying a clearer text image quality. The density of the boundary portion may be the same as the density of the original image. Also, if ink is used as a developer, spreading of the ink may be adjusted, and the boundary portion may be emphasized. Furthermore, since different densities may be applied to the boundary portion and the non boundary portion, an image quality of the same level to the naked eye may be accomplished with a small quantity of the developer.

Hereinafter, a process of the merged data generating unit 138 generating the merged data based on the binary data, the boundary detecting result by the boundary detecting unit 139, and the continuous tone data will be described with reference to FIG. 9. FIG. 9 is a schematic view of the merged data generating unit 138 of the image processing unit 130b illustrated in FIG. 8.

A process of generated merged data C of the color cyan (C) will now be described. If binary data C is 1, and the binary data C corresponds to a boundary (i.e., a boundary result is 1), third tone data C is selected as the merged data C. If the binary data C is 1, and the binary data C does not correspond to a boundary (i.e., the boundary result is 0), the second tone data C is selected as the merged data C. Accordingly, the density of a text area corresponding to the binary data C can be lower than an original image, and the density of a boundary portion of the text area can be higher than that of a non-boundary portion.

For example, it is assumed that continuous tone data C of the color C has tones of 256 increments of 0-255, 255 is regarded as 100% density, and 0 is regarded as 0% density (i.e., blank). In this case, the second tone data C may be a value less than 255, which is a lower density than the 100% density. That is, the second tone data C may be a value greater than 0 and less than 255. As the value of the second tone data C approaches 255, the density of the text area of the final image increases. Conversely, as the value of the second tone data C approaches 0, the density of the text area of the final image decreases. Here, the second tone data C may be a value corresponding to a density of approximately 80-90%. In this case, the third tone data C has a larger value than the second tone data C. For example, if the value of the second tone data C is selected to be 200, the value of the third tone data C may be selected to exceed 200. The second tone data C and the third tone data C may be determined by an experience or an experiment. Moreover, the third tone data C may, although not necessarily, be determined to be 255, which is the 100% density. In this case, the density of only the non-boundary portion of the text area may be reduced. Also, if the binary data C is 0, the continuous tone data C is selected as the merged data C irrespective of the boundary result of the binary data C. Accordingly, the binary data C and the continuous tone data C divided by the decoding unit 132 are merged as the merged data C.

Processes of generating merged data M, Y and K based on continuous tone data M, Y and K of the colors M, Y and K, binary data M, Y and K of colors corresponding thereto, and boundary results M, Y and K of the binary data M, Y and K may be the same as the generating process of the merged data of the color C described above. Accordingly, a detailed description thereof will be omitted herein.

Here, the second tone data C, M, Y and K and the third tone data C, M, Y and K may have different values for each color. That is, third tone data C of cyan C, third tone data Y of yellow Y, third tone data M of magenta M, and third tone data K of black K may have different values. For example, the third tone data C may be determined as 250, the third tone data Y may be determined as 230, the third tone data M may be determined as 210, and the third tone data K may be determined as 210. Accordingly, if printed on a white print medium, the density of a boundary portion of colors difficult to discern to the naked eye (such as cyan and/or yellow) may be adjusted to be as high as possible.

The merged data C, M, Y and K of colors are half-toned by the half-toning unit 135, and are then transmitted to a printing unit of the image forming apparatus including the image processing unit 130b illustrated in FIG. 8. Accordingly, the printing unit includes a plurality of developer cartridges storing a developer corresponding to each color. The developer cartridges may include ink or a toner. The printing unit 120 applies a developer of a color corresponding thereto stored in each developer cartridge on a print medium in order based on data corresponding to the half-toned color, and finally prints a color image.

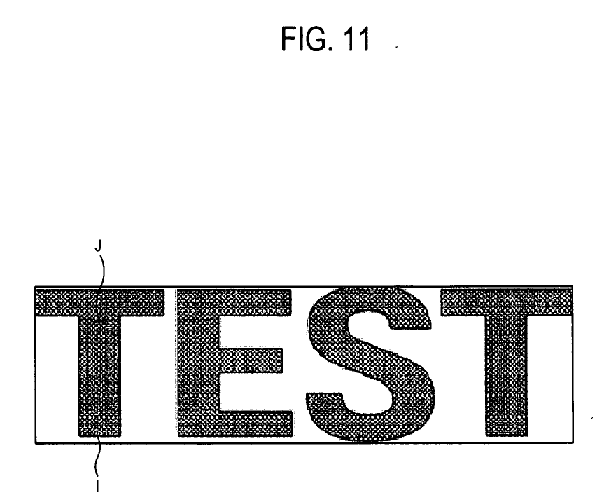

FIGS. 10 and 11 are enlarged views of a final image by the image forming apparatus 100 including the image processing unit 130 illustrated in FIG. 2 (FIG. 10), and a final image by an image forming apparatus including the image processing unit 130b illustrated in FIG. 8 (FIG. 11). Specifically, FIGS. 10 and 11 illustrate a black text “TEST” printed on a print medium, and show that the densities of inner parts of text areas J and H of “TEST” decrease. In FIG. 11, the density of a boundary portion I of the text area J becomes higher than a non boundary area J thereof. Accordingly, the quality of the text may be improved, and it becomes easier to discern the text to the naked eye.

Also, the print data is described above to be received from the host apparatus. Alternatively, the print data may be generated in the image forming apparatus itself. For example, if the image forming apparatus includes a scanner, the print data may be generated by scanning a document via the scanner. Here, the print data may be transmitted to an interface unit 140 (illustrated in FIG. 1) in a state divided into continuous tone data corresponding to the image area and binary data corresponding to the text area, and compressed by the MRC method. In this case, the interface unit 140 may be a data bus transmitting the print data generated by the scanner to the image processing unit 130, 130a, and 130b.

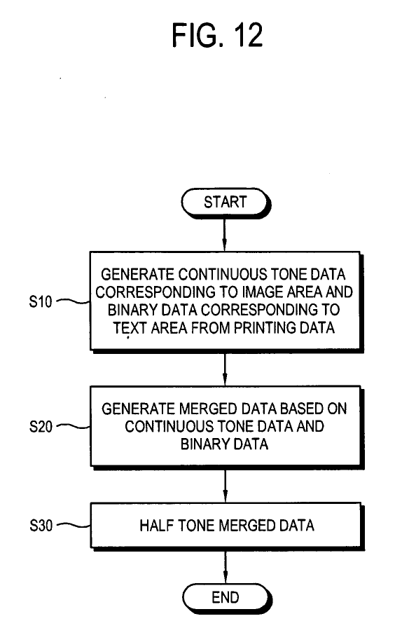

Hereinafter, a printing method of an image forming apparatus according to embodiments of the present invention will be described with reference to FIGS. 12 to 15B. FIG. 12 is a flowchart of a printing method of an image forming apparatus 100 according to an embodiment of the present invention. Specifically, the printing method described with reference to FIG. 12 relates to the image processing unit 130 illustrated in FIG. 2. Referring to FIG. 12, continuous tone data corresponding to an image area and binary data corresponding to a text area are generated from print data in operation S10.

Merged data is generated based on the continuous tone data and the binary data in operation S20. Here, the merged data is generated so that a density of a final image corresponding to final data can be less than a density of an original image corresponding to the print data.

The merged data is half-toned to generate the final data in operation S30. The half-toned final data is transmitted to a printing unit 120 (such as illustrated in the image forming apparatus of FIG. 1), and the final image corresponding to the final data is formed on a print medium by the printing unit 120.

Accordingly, the density of the final image is reduced, thereby saving a developer. Also, if the developer is ink, the density of the final image is reduced to prevent the ink from spreading on a print medium. Moreover, an image quality on the print medium is improved, and an ink drying time is reduced.

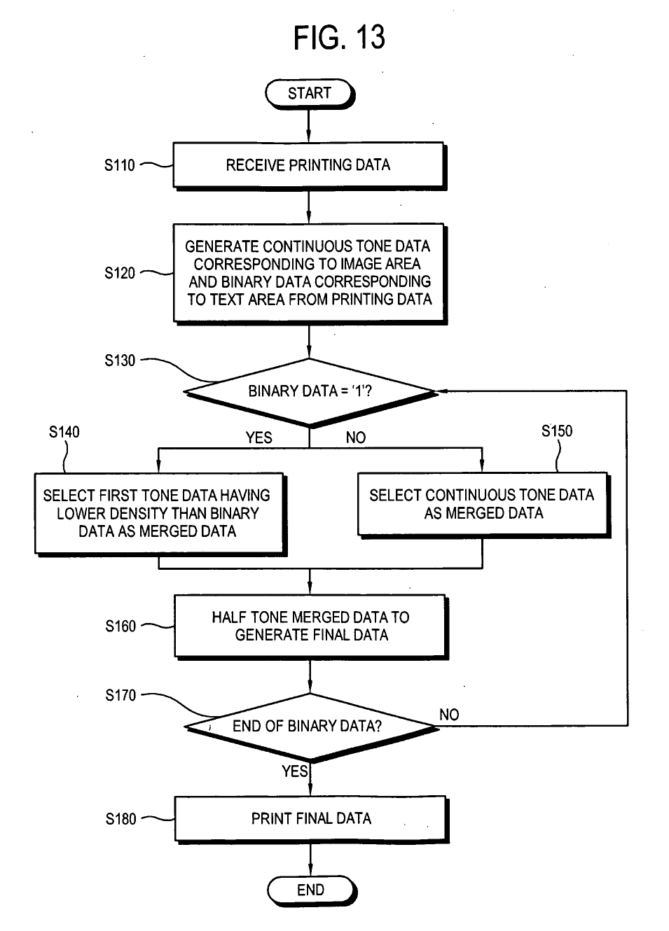

Hereinafter, a printing method of an image forming apparatus according to another embodiment of the present invention will be described with reference to FIG. 13. Referring to FIG. 13, print data is received in operation S110. The print data may be data divided into continuous tone data corresponding to an image area and binary data corresponding to a text area, and compressed by the MRC method. Furthermore, the print data may be received from a host apparatus such as an external personal computer, or may be received from a scanning unit in the image forming apparatus 100.

Continuous tone data corresponding to an image area and binary data corresponding to a text area are generated from the print data in operation S120. It is determined whether the binary data is 1 in operation S130. That is, it is determined whether the text area is an area to which a developer is applied.

If the binary data is 1 (operation S130) (i.e., the text area is an area to which the developer is applied), first tone data having a lower density than the binary data is selected as merged data in operation S140. Conversely, if the binary data is 0 (operation S130) (i.e., the text area is not an area to which the developer is applied), the continuous tone data is selected as the merged data in operation S150.

The merged data is half-toned to generate final data in operation S160. Then, it is determined whether an end of the binary data is reached in operation S170, such that the operations S130 to S160 are repeated until the end of the binary data is reached. The generated final data is printed in operation S180.

Accordingly, in the merging operation S140, the binary data corresponding to the text area is replaced by the first tone data having a lower density, thereby adjusting the density of the final image. Specifically, the density of an image corresponding to the text area of the final image is lower than the density of an original image corresponding to the print data. Accordingly, if a developer is ink, spreading of the ink is reduced, thereby obtaining a clearer text image. Also, a developer including ink or a toner is saved.

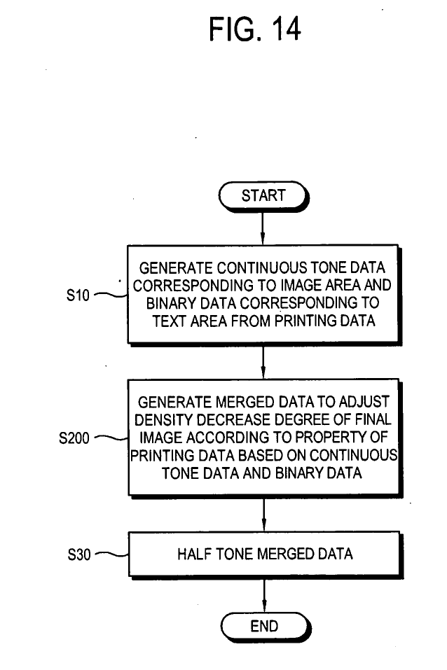

Hereinafter, a printing method of an image forming apparatus according to another embodiment of the present invention will be described with reference to FIG. 14. Referring to FIG. 14, continuous tone data corresponding to an image area and binary data corresponding to a text area are generated from print data in operation S10.

Then, merged data is generated to adjust a density decrease degree of a final image to be formed on a print medium according to a property of the print data based on the continuous tone data and the binary data in operation S200. Here, the property of the print data includes a boundary of the text area. Specifically, the boundary of the text area is detected, and the merged data is generated so that the density decrease degrees of a boundary portion and a non boundary portion differ according to the boundary detecting result. For example, if the density of the boundary portion is reduced by 10% in comparison with an original image corresponding to the binary data or the continuous tone data, the density of the non boundary portion may be reduced by 20% in comparison therewith. Accordingly, the density of the boundary portion of the image area or the text area of the final image formed on a printing medium appears higher than the density of the non boundary portion thereof. As a result, a clearer text image quality is supplied to a user.

Then, the merged data is half-toned to generate the final data in operation S30. The half-toned final data is transmitted to a printing unit 120 (such as illustrated in the image forming apparatus of FIG. 1), and the final image corresponding to the final data is formed on a print medium by the printing unit 120.

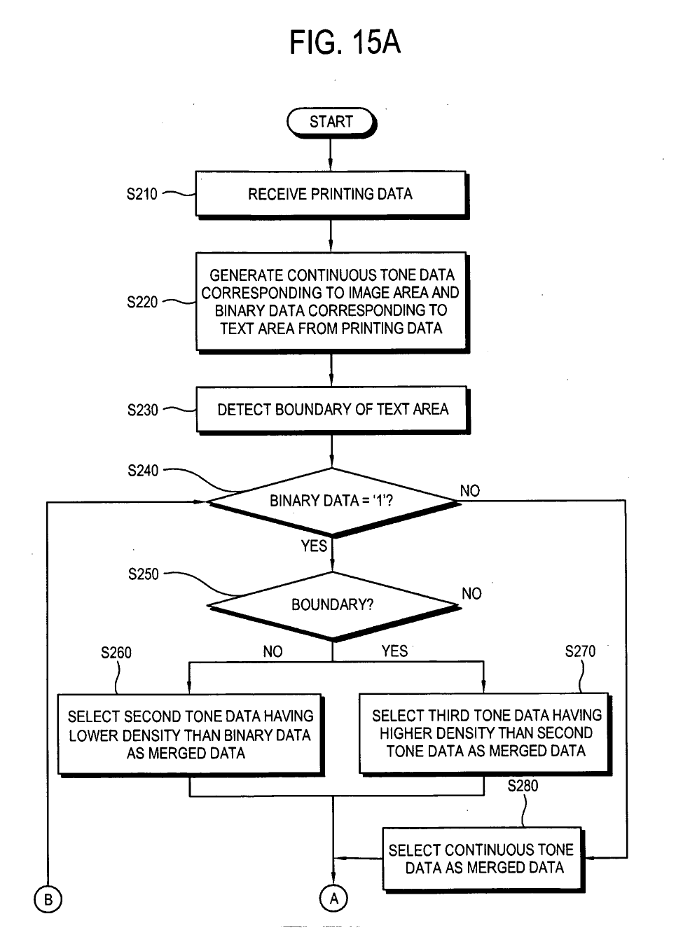

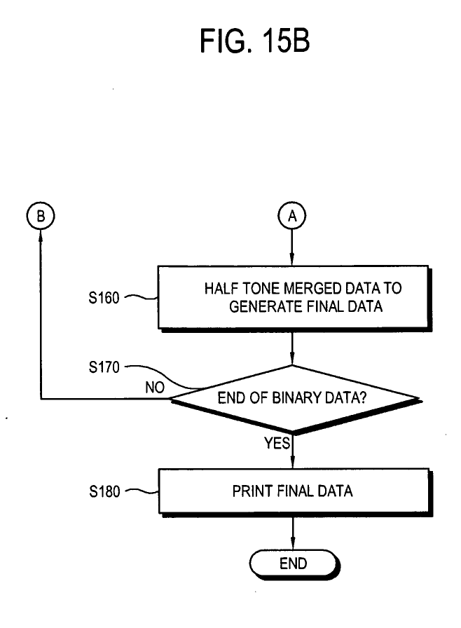

Hereinafter, a printing method of an image forming apparatus according to another embodiment of the present invention will be described with reference to FIGS. 15A and 15B. Referring to FIGS. 15A and 15B, print data is received in operation S210. Here, the print data may be data divided into continuous tone data corresponding to an image area and binary data corresponding to a text area, and compressed by the MRC method.

Continuous tone data corresponding to an image area and binary data corresponding to a text area are generated from the print data in operation S220. The compressed print data may be decoded to be divided into the continuous tone data and the binary data. A boundary of the text area is detected in operation S230. Here, the boundary detecting may employ an outline detecting algorithm (such as Sobel, Prewitt, Robert, Laplacian, Canny, etc.).

It is determined whether the binary data is 1 in operation S240. That is, it is determined whether the text area is an area to which a developer is applied. If the binary data is 1 (operation S240) (i.e., the text area is an area to which the developer is applied), it is determined whether the binary data corresponds to a boundary in operation S250. If the binary data does not correspond to the boundary (operation S250), second tone data having a lower density than the binary data is selected as merged data in operation S260. On the other hand, if the binary data corresponds to the boundary (operation S250), third tone data having a higher density than the second tone data is selected as the merged data in operation S270. However, if the binary data is 0 (operation S240) (i.e., the text area is not an area to which the developer is applied), the continuous tone data is selected as the merged data in operation S280.

The merged data is half-toned to generate final data in operation S160. It is determined whether an end of the binary data is reached in operation S170, such that the operations S240 to S280 are repeated until the end of the binary data is reached. The generated final data is printed on a print medium as the final image corresponding to the final data by a printing unit 120 (such as illustrated in the image forming apparatus of FIG. 1) in operation S180.

Accordingly, a density can be adjusted by discerning the boundary portion and the non boundary portion of the text area or the image area. Also, the density of the boundary portion can be adjusted to be higher then the density of the non boundary portion, thereby enhancing the quality of a text. Accordingly, a user can easily identify the text. Moreover, a developer including ink or a toner is saved.

As described above, an image forming apparatus and a printing method thereof according to aspects of the present invention have the following advantages. First, a density of a final image formed on a print medium can be adjusted to be different than a density of an original image. Second, a developer spreading on a print medium is reduced. Third, a developer is efficiently used and, thus, saved. Fourth, a boundary of a final image to be formed on a print medium is emphasized to improve an image quality.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. A printing method of an image forming apparatus, the printing method comprising:
generating, from print data, continuous tone data corresponding to an image area of the print data and binary data corresponding to a text area of the print data;
generating merged data based on the continuous tone data and the binary data; and
performing a half-toning of the merged data to generate final data to be printed on a print medium.

2. The printing method as claimed in claim 1, wherein the generating of the merged data comprises generating the merged data to reduce a density of a final image corresponding to the final data as compared to a density of an original image corresponding to the print data.

3. The printing method as claimed in claim 2, wherein the generating of the merged data to reduce the density of the final image comprises selecting first tone data that has a lower density than the binary data or the continuous tone data as the merged data depending on the binary data.

4. The printing method as claimed in claim 3, wherein the selecting comprises:
selecting the first tone data that has the lower density than the binary data if the binary data is equal to 1; and
selecting the continuous tone data if the binary data is equal to 0.

5. The printing method as claimed in claim 3, wherein the first tone data is variably set.

6. The printing method as claimed in claim 2, wherein the generating of the merged data to reduce the density of the final image comprises generating the merged data so that a density decrease degree of the final image is set according to a property of the print data.

7. The printing method as claimed in claim 6, wherein the property of the print data is based on a boundary of the text area.

8. The printing method as claimed in claim 7, wherein the generating of the merged data so that the density decrease degree is set according to the property of the print data comprises generating the merged data so that a density of the boundary of the text area in the final image is greater than a density of a non-boundary of the text area in the final image.

9. The printing method as claimed in claim 6, wherein the generating of the merged data so that the density decrease degree is set according to the property of the print data comprises:
determining whether the binary data corresponds to a boundary of the text area; and
selecting, as the merged data, second tone data that has a lower density than the binary data if the binary data is determined to not correspond to the boundary, third tone data that has a higher density than the second tone data if the binary data is determined to correspond to the boundary, or the continuous tone data depending on the binary data.

10. The printing method as claimed in claim 9, wherein the third tone data has a higher density than the binary data.

11. A computer-readable recording medium encoded with the method of claim 1 and implemented by at least one computer.

12. An image forming apparatus, comprising:
an interface unit to receive print data; and
an image processing unit to generate, from the print data, continuous tone data corresponding to an image area of the print data and binary data corresponding to a text area of the print data which is received through the interface unit, to generate merged data based on the continuous tone data and the binary data, and to perform a half-toning of the merged data to generate final data to be printed on a print medium.

13. The image forming apparatus as claimed in claim 12, wherein the image processing unit generates the merged data to reduce a density of a final image corresponding to the final data as compared to a density of an original image corresponding to the print data.

14. The image forming apparatus as claimed in claim 13, wherein the image processing unit comprises a multiplexer to select first tone data that has a lower density than the binary data or the continuous tone data as the merged data depending on the binary data.

15. The image forming apparatus as claimed in claim 14, wherein the first tone data is variably set.

16. The image forming apparatus as claimed in claim 13, wherein the image processing unit generates the merged data so that a density decrease degree of the final image is set according to a property of the printing data.

17. The image forming apparatus as claimed in claim 16, wherein the property of the print data is based on a boundary of the text area.

18. The image forming apparatus as claimed in claim 17, wherein the image processing unit generates the merged data so that a density of the boundary of the text area in the final image is greater than a density of a non-boundary of the text area in the final image.

19. The image forming apparatus as claimed in claim 16, wherein the image processing unit comprises:
a boundary detecting unit to determine whether the binary data corresponds to a boundary of the text area; and
a multiplexer to select, as the merged data, second tone data that has a lower density than the binary data if the binary data is determined to not correspond to the boundary, third tone data that has a higher density than the second tone data if the binary data is determined to correspond to the boundary, or the continuous tone data depending on the binary data.

20. The image forming apparatus as claimed in claim 19, wherein the third tone data has a higher density than the binary data.
